(19) United States
(12) Patent Application Publication
(10) Pub. No.: US 2022/0172532 A1
(43) Pub. Date: Jun. 2, 2022

(54) AUTOMATED ACCESS SYSTEMS FOR PERMITTING ACCESS THROUGH AN ENTRANCEWAY

(71) Applicant: Georges Raymond Brow, Georgetown Royalty (CA)

(72) Inventor: Georges Raymond Brow, Georgetown Royalty (CA)

(21) Appl. No.: 17/466,597

(22) Filed: Sep. 3, 2021

(30) Foreign Application Priority Data
Nov. 26, 2020 (CA) 3101854
Nov. 30, 2020 (CA) 3101414

(51) Int. Cl. G07C 9/00; G07C 9/20

(52) U.S. Cl. CPC G07C 9/00563; G07C 9/20; G07C 9/00309

(57) ABSTRACT

The present invention relates to an access system for permitting access through an entranceway when a visitor provides at least a vaccination confirmation of the visitor and a vaccination confirmation code. The present invention also relates to an access system for an entranceway having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor.

### FIELD OF THE INVENTION

The present invention relates generally to an access system for permitting access through an entranceway when a visitor provides, for example, a vaccination confirmation of the visitor and a vaccination confirmation code. The present invention also relates to an automated access system for an entranceway having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor. If facial recognition determines that the visitor is not wearing a mask, the motion/presence detector will remain armed, and the door shall remain locked.

### DESCRIPTION OF THE PRIOR ART

Many diseases, such as hepatitis, have been found to be transmittable due to a failure of people to wash their hands. In fact, certain public health laws require those in, for example, the food distribution field to wash their hands each time they exit these facilities before they resume their duties. In areas such as hospitals or labs, the spread of germs and contagions is a serious health concern. For this reason, many such facilities post visual signs which are intended to remind a person to wash their hands before entry/exit, but such signs can be easily ignored, and thus stronger warning systems are required if such spread of disease is to be checked or inhibited. While signs may be innocuous means of warning the public of the need to wash their hands, with a view to reducing the spread of germs and contagions, stronger warning means that provide audible or visual alerts should be used in certain public facilities to provide these reminders, such as for employees of a restaurant, hospitals, food processing or research facilities, or the like.

Furthermore, considering the spread of COVID-19, there exists an imminent likelihood that many establishments will require proof of vaccination before permitting entry to these establishments. There also exist many situations in society presently where use of masks are mandatory or strongly encouraged to try to limit the spread of this virus. It therefore would be beneficial for a system to exist providing an access system for an entranceway for permitting access through the entranceway when a visitor provides, for example, a vaccination confirmation of the visitor and a vaccination confirmation code. It would also be beneficial for an access system to exist where entry of visitors into certain areas could be safely and effectively controlled to require the use of such masks before gaining entry.

Accordingly, there is a need for an access system for permitting access through an entranceway when a visitor at least provides, for example, a vaccination confirmation of the visitor and a vaccination confirmation code. Further, there is also a need for an automated access system for an entranceway, and more particularly, to an automated access system for an entranceway having a facial recognition device mounted proximate to an entranceway that, when utilized, deactivates temporarily a motion/presence detector scanning an area immediately adjacent or close to the entranceway and permits entry or exit for the visitor. If facial recognition determines that the visitor is not wearing a mask, the motion/presence detector will remain armed, and the door shall remain locked, the proximity detector will remain armed, and the door shall remain locked.

There is also a need for a system which includes validation and confirmation that the visitor has tested negative for the coronavirus (or other selected communicable diseases) before allowing passage through the entranceway.

To this end, the present invention effectively addresses these needs.

### SUMMARY OF THE INVENTION

A general object and advantage of the present invention is to provide an improved access system for permitting access through an entranceway when a visitor, at least, provides a vaccination confirmation of the visitor and a vaccination confirmation code before gaining entry.

A still further object and advantage of the present invention is to provide an improved automated access system for an entranceway having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor.

A still further object and advantage of the present invention is to provide an improved automated access system for an entranceway wherein, if facial recognition determines that the visitor is not wearing a mask, the motion/presence detector will remain armed, and the door shall remain locked.

Yet another object and advantage of the present invention is to provide an improved access system for an entranceway having a message conveying device mounted proximate to the entranceway and being electrically coupled and in electronic communication with the facial recognition device, for providing an access allowed signal when the facial recognition device determines that a person is wearing a mask, and denying entry when the person is determined to not be wearing a mask.

According to one aspect of the present invention, there is provided an access system for an entranceway comprising a processor mounted proximate to the entranceway; a scanning device in electronic communication with the processor for permitting access through the entranceway when a visitor achieves an access allowed criteria selected from the group consisting of: —a vaccination confirmation of the visitor and a vaccination confirmation code; —the vaccination confirmation of the visitor and an RFID pass; —a face mask verification and the vaccination confirmation code; —the face mask verification, a verification of a set allowable temperature for the system to gain entry and the vaccination confirmation code; —the face mask verification, the verification of the set allowable temperature for the system to gain entry, the vaccination confirmation code and the RFID pass; and —the verification of the set allowable temperature for the system to gain entry, the vaccination confirmation code and the RFID pass.

According to another aspect of the present invention, there is provided an access system for an entranceway comprising a facial recognition device mounted proximate to the entranceway; a motion/presence detector mounted proximate to the entranceway and constructed and arranged for detecting an approach of a visitor to the entranceway; a processor mounted proximate to the entranceway and being electrically coupled to, and in electronic communication with, the facial recognition device and the motion/presence detector; and message conveying means mounted proximate to the entranceway and being electrically coupled and in electronic communication with the facial recognition device, the message conveying means providing an access allowed signal when the facial recognition device determines that a person is wearing a mask, and denies entry when the person is determined to not be wearing a mask.

According to another aspect of the present invention, there is provided a method for manufacturing an access system for an entranceway comprising the steps of providing a facial recognition device mounted proximate to the entranceway; providing a motion/presence detector mounted proximate to the entranceway and constructed and arranged for detecting an approach of a visitor to the entranceway; providing a processor mounted proximate to the entranceway and being electrically coupled to, and in electronic communication with, the facial recognition device and the motion/presence detector; and providing message conveying means mounted proximate to the entranceway and being electrically coupled and in electronic communication with the facial recognition device, the message conveying means providing an access allowed signal when the facial recognition device determines that a person is wearing a mask, and denies entry when the person is determined to not be wearing a mask.

According to yet another aspect of the present invention, there is provided a method for manufacturing an access system for an entranceway comprising the steps of providing product dispensing means constructed and arranged to be mounted proximate to the entranceway; providing a facial recognition device constructed and arranged to be mounted proximate to the entranceway; providing a motion/presence detector constructed and arranged to be mounted proximate to the entranceway and constructed and arranged for detecting an approach of a visitor to the entranceway; providing a processor constructed and arranged to be mounted proximate to the entranceway and in electronic communication with the facial recognition device, the product dispensing means and the motion/presence detector; and providing message conveying means mounted proximate to the entranceway and in electronic communication with the processor, the message conveying means providing an access allowed signal when the facial recognition device determines that a person is wearing a mask, and denies entry when the person is determined to not be wearing a mask.

A still further aspect of the present invention provides a method for manufacturing an access system for an entranceway comprising the steps of providing a processor mounted proximate to the entranceway; providing a scanning device in electronic communication with the processor for permitting access through the entranceway when a visitor achieves an access allowed criteria selected from the group consisting of: —a vaccination confirmation of the visitor and a vaccination confirmation code; —the vaccination confirmation of the visitor and an RFID pass; —a face mask verification and the vaccination confirmation code; —the face mask verification, a verification of the set allowable temperature and the vaccination confirmation code; —the face mask verification, the verification of the set allowable temperature, the vaccination confirmation code and the RFID pass; and-the verification of the set allowable temperature, the vaccination confirmation code and the RFID pass.

According to a still further aspect of the present invention, there is provided an access system for an entranceway comprising product dispensing means mounted proximate to the entranceway; a facial recognition device mounted proximate to the entranceway; a motion/presence detector mounted proximate to the entranceway and constructed and arranged for detecting an approach of a visitor to the entranceway; a processor mounted proximate to the entranceway and in electronic communication with the facial recognition device, the product dispensing means and the motion/presence detector; and message conveying means mounted proximate to the entranceway and in electronic communication with the processor, the message conveying means providing an access allowed signal when the facial recognition device determines that a person is wearing a mask, and denies entry when the person is determined to not be wearing a mask.

According to another aspect of the present invention, there is provided an access system for an entranceway comprising a facial recognition device mounted proximate to the entranceway; a scanning device in electronic communication with the system for detecting confirmation that a visitor has tested negative for a communicable disease; a motion/presence detector mounted proximate to the entranceway and constructed and arranged for detecting an approach of the visitor to the entranceway; a processor mounted proximate to the entranceway and being electrically coupled to, and in electronic communication with, the facial recognition device and the motion/presence detector; and message conveying means mounted proximate to the entranceway and being electrically coupled and in electronic communication with the facial recognition device, the message conveying means providing an access allowed signal when the facial recognition device determines that a person is wearing a mask, and denies entry when the person is determined to not be wearing a mask.

According to yet another aspect of the present invention, there is provided an access system for an entranceway comprising product dispensing means mounted proximate to the entranceway; a scanning device in electronic communication with the system for detecting a confirmation that a visitor has tested negative for a communicable disease; a facial recognition device mounted proximate to the entranceway; a motion/presence detector mounted proximate to the entranceway and constructed and arranged for detecting an approach of the visitor to the entranceway; a processor mounted proximate to the entranceway and in electronic communication with the facial recognition device, the product dispensing means and the motion/presence detector; and message conveying means mounted proximate to the entranceway and in electronic communication with the processor, the message conveying means providing an access allowed signal when the facial recognition device determines that a person approaching the entranceway is wearing a mask, and denies entry when the person is determined to not be wearing a mask.

### BRIEF DESCRIPTION OF THE DRAWINGS

A preferred embodiment of the present invention is described below with reference to the accompanying drawing, in which:

FIG. 1 illustrates a front view of the automated mask wearing recognition reminder and unlocking system for an entranceway of the present invention.

### DESCRIPTION OF THE PREFERRED EMBODIMENT

The present invention relates to an access system for permitting access through the entranceway when a visitor provides, for example, at least a vaccination confirmation of the visitor and a vaccination confirmation code. The present invention also relates to an automated access system for an entranceway having a facial recognition device mounted proximate to the entranceway that, when utilized and it is determined a visitor is wearing a mask, deactivates temporarily a motion/presence detector scanning an area immediately adjacent or close to the entranceway and permits entry (or exit) for the visitor. If facial recognition determines that the visitor is not wearing a mask, the motion/presence detector will remain armed, and the door shall remain locked. The system can also include validation and confirmation that the visitor has tested negative for the coronavirus (or other selected communicable diseases) before allowing passage through the entranceway.

It will be understood that the system and method of the present invention for an entranceway (and all components thereof) is, in an exemplary embodiment, in electronic communication with the Internet and/or other communications systems (such as through a network) via Wi-Fi, radio, Bluetooth, for example, through means of an accessible network and processor 7 interconnected with the system.

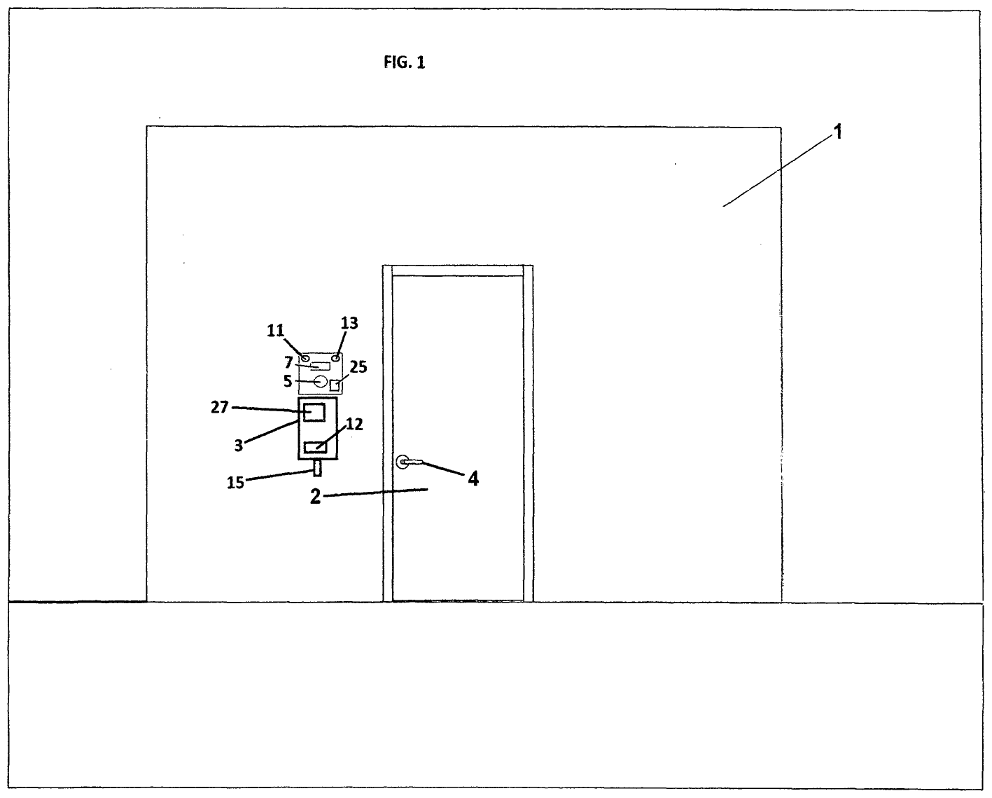

With reference now to FIG. 1, the embodiment of the automated access system for an entranceway, generally designated by the reference numeral 1, will now be described. In one embodiment, the system is electrically coupled to a primary power supply (not shown), preferably by hardwiring an electrical supply to components of the system. In an alternative embodiment, an alternate power source, such as battery power, could also be utilized. The automated access system 1 generally comprises a disinfectant dispenser 3 that is mounted proximate to the entranceway 2. In one embodiment, the disinfectant dispenser 3 is mounted on a wall proximate and adjacent to the entranceway 2, though it will be readily understood that variations as to the placement of the disinfectant dispenser 3 are possible, as would be readily understood by one skilled in the art. For example, the disinfectant dispenser 3 could be mounted on another component, such as a tower, in close proximity to the entranceway 2. It will also be understood that disinfectant dispenser 3 is, preferably, arranged to be mounted on the outside or inside of a building, near an exterior doorway, or located inside the building's vestibule, and that a second, or indeed a plurality of disinfectant dispensers may be utilized to compel hand sanitization prior to exit or entry through the entranceway 2.

A motion/presence detector 5 is mounted on the disinfectant dispenser 3 and is adapted for detecting an approach of a visitor to the entranceway 2, it being understood that the motion/presence detector 5 can be conventional in nature, and that variations as to the placement of the motion/presence detector 5 are possible. Such a motion/presence detector 5 will preferably have a camera (not shown) in association therewith, whereby approaching visitors can be visually scanned for compliance with wearing a mask before entering the entranceway 2. It will also be understood that a proximity detector could also be utilized, if desired. In one embodiment, a processor 7 is housed within (or in proximity to) the disinfectant dispenser 3 it being understood that the processor 7 is in electronic communication with other components of the system, such as the motion/presence detector 5, message conveying apparatus 25, access allowed emitter 11 and access denied emitter 13, thermal temperature sensor 27, as hereinafter described, and that these components are also in with electronic communication with the Internet and/or other communications systems.

In a preferred embodiment, the access system for an entranceway 1 can have a thermal temperature sensor 27 (as seen in FIG. 1) in electronic communication with the processor 7 and other components of the system, for monitoring a temperature of an approaching visitor, whereby those with an elevated temperature will be restricted access through the entranceway, and users of a set allowable temperature, will be permitted entry through the entranceway. This set allowable temperature can, of course be variably set, and it will be understood that such temperature sensor 27 could be positioned at numerous locations proximate to the entranceway, or on other components of the system. Should a visitor exceed this set allowable temperature, entry through the doorway can be denied.

A data storage device 12 can be mounted on the disinfectant dispenser 3, or at various other locations proximate to the system 1, for storing events and history relating to use of the system 1, it being understood that variations to the type of information collected and stored by the data storage device 12 are possible. Examples of such information that could be collected and stored in the data storage device could include (but is not limited to) the number of people entering and exiting the building, the number of persons denied entry, the number of people and/or percentage of people who used the disinfectant dispenser 3, and malfunction alerts, as well as tracking entry and exits of visitors to ensure legal capacity limits as to visitor limits within a space are maintained. In an alternative embodiment, the data storage device can also store a “low battery” warning that can be issued through the message conveying apparatus 25, when a battery powered power source is utilized and power is low, and can also be used to collect and store marketing information relating to the visitors passing or exiting through the entranceway 2. Further information that can be collected and stored can relate to (but is not limited to) the collection of data when situations arise where visitors are required to answer certain questions to gain entry.

In operation, when approaching the entranceway 2 to facility, in one embodiment, the visitor utilizes disinfectant dispenser 3 by means of disinfectant dispensed from spout 15 to gain unalarmed entry to or exit from the facility through the entranceway 2. At the same time, thermal temperature sensor 27 scans the visitor to assure compliance with the set allowable temperature, and the motion/presence detector 5 scans the visitor to assure compliance with wearing a mask before entering the entranceway 2.

If the visitor is in compliance with of these objectives and standards (or achieving a pre-set standard for gaining entry) the components of the system transmit signals to a processor 7, which then deactivates temporarily the motion/presence detector 5 scanning an area immediately adjacent or close to the entranceway 2, and thus permits entry or exit for the visitor. At the same time, processor 7 activates access allowed emitter 11 to provide a visual indication to the visitor that passage is permitted, and, simultaneously also activates an access allowed audio tone to be played through message conveying apparatus 25.

However, in one embodiment, it will be understood that if the disinfectant dispenser 3 has not been utilized, or if thermal temperature sensor 27 and the motion/presence detector 5 determines a visitor is not in compliance with the set allowable temperature, or is not wearing a mask, respectively, then no signal from the system 1 will be transmitted to the processor 7, and the entranceway 2 will remain in a locked (closed) position. In this scenario, the motion/presence detector 5 issues an access denied audio tone to be played through message conveying apparatus 25, and, can also simultaneously activate the access denied emitter 13 to provide a visual indication to the visitor that passage is not permitted. The message conveying apparatus 25 can also be used to convey, in one embodiment, relevant pre-recorded announcements, that can be chosen or required as needed.

In one embodiment, the visual indication that is given to the visitor to indicate that passage is permitted can be a signal, visual or otherwise, (such as a “green” light), and the visual indication that is given to the visitor to indicate that passage is not permitted is another form of signal (such as, for example only, a “red light”), though it will, of course, be understood that numerous variations as to this can be effected. As seen in FIG. 1, the visitor could utilize handle 4 on the door to gain entry or exit, or, alternatively, the entranceway 2 could contain no door at all.

In a still further embodiment, it will be understood that access through the entranceway 2 can also be accomplished by means of a swipe card (now shown) for those deemed to have appropriate clearance for the system 1. Alternatively, the mask recognition system could also be bypassed by using a code entered through a keypad, a RFID/NFC key fob/swipe cards (as noted) or a code sent over the Internet/network communications system.

It will be appreciated by those skilled in the art that the processor 7 is, preferably, in electronic communication with the disinfectant dispenser 3, and other components of the system, and can communicate with these through electromagnetic signals, or a combination thereof, as is conventionally known. It will also be appreciated by those skilled in the art that the electromagnetic signals can include infra-red, RF, or any other electromagnetic signal, as are well known in the art. Alternatively, the connection between these components could also be hard wired.

In a further embodiment, the processor 7 may also issue an audible message to individuals who are attempting to enter (or exit), and who have not utilized the disinfectant dispenser 3, or are not wearing a mask when approaching the entranceway 1, through the playing of a recorded audio message or reminder (such as, “Soap and Rinse your hands”, “Please place a mask over your face”, or “Please sanitize your hands to gain entry to this building”) through the message conveying apparatus 25, it being understood that variations as to the type of message conveyed are possible. It will, of course, be understood that multiple reminders could be effected, if the processor is so programmed. It will also be understood that either of the access allowed signal and access denied signal can be displayed substantially simultaneously with an issuance of a respective one of the access allowed audio tone and the access denied audio tone.

It will also be understood that such reminder messages can also be conveyed in the form of a visual reminder, such as through use of an LED sign (not shown), or other types of sounds that are emitted for the user to hear, it being understood that variations to these conveyed messages are possible.

In a still further embodiment, when supplies are low in the disinfectant dispenser 3, the signal emitter (not shown) from the soap/disinfectant dispenser 3 transmits a signal to the processor 7 to activate the low supply (or low soap) warning to be played through message conveying apparatus 25. In much the same manner, when battery power for the system is low, the processor 7 activates the low battery warning to be played through message conveying apparatus 25 when this occurs.

In a further embodiment of the present invention, events, data and information regarding the system 1 of the present invention (contained in data storage device 12) can be accessed via the internet or over an inter-connected network, remotely or on-site. It will be understood that through such interconnection, actions, settings or overview of the system 1 can be observed or changed via the internet or the inter-connected network. It will also be understood that these can also be changed manually on site by the operator. Preferably, components of the system may, if desired, also have their own web address, through which an operator will have security access to access any collected data from the data storage device 12.

In a further embodiment, the present invention may be equipped with an anti-vandalism feature (not shown) which is embedded in the disinfectant dispenser 3, or other component of the system, and which sends out a distress signal, via the processor 7, through wireless transmission or through other means previously described herein, to a remote operator advising of the situation.

In a still further embodiment of the present invention, the disinfectant dispenser 3 or other components of the system 1 can be configured for radio-frequency identification (RFID), or card reader information, whereby a visitor approaching the doorway could utilize a tag card, or swipe card, to temporarily deactivate the motion/presence detector 5 scanning an area immediately adjacent or close to the entranceway 2, and thus permits entry or exit for the visitor.

In another embodiment of the present invention the unlocking of an entranceway, in addition to the previously noted criteria, can also include validation and confirmation that the visitor has tested negative for the coronavirus (or other selected communicable diseases) before being able to pass through the entranceway. Such a confirmation, after the visitor has achieved a negative coronavirus test, could be effected through use of an application on a mobile phone, which generates a confirmation code that could be scanned at the entranceway. Another variation could be a confirmation code printed on paper that could be shown and/or scanned, much as would be done with a paper boarding pass at an airport, though it will be understood that numerous variations to this could be effected.

It will be understood that confirmation codes could be utilized such as bar codes, a QR code, a datamatrix code, or other machine readable optical labels, as would be apparent to one skilled in the art. With respect to QR codes being utilized, such code being placed on a fully vaccinated person's phone, when the QR code is later scanned at an entranceway, a “positive vaccination” (for example only) message will appear in green. If the person is not fully vaccinated, the message displayed will be “non-vaccinated” and they will be denied entry. In one embodiment, someone is considered “positively vaccinated” seven days after receiving the second dose of the vaccine, though this time-line could, of course, be varied.

Such QR codes allow citizens to record their QR code and have it on their phone at all times to present to merchants, if need be. It will be understood that, in the same mobile phone application, citizens could also be able to download QR codes of their family members, and that merchants can scan these QR code, which will show the customer's name and vaccination status.

In addition, it will be appreciated that numerous other variations and additions could be utilized with respect to the unlocking of, and passage through, the entranceway, in addition to the previously noted criteria. These can include but are not limited to, magnetic locks on an entranceway door, electric strikes, physical three arm turnstiles restricting access through the entranceway, optical turnstiles, electric gates or the like, as would be apparent to one skilled in the art. Any (or all) of these could be arranged in series, and controlled as such, with any of the previously noted access criteria, or selectively applied on an “as needed” basis, if desired.

As examples only, this could entail (but is not limited to) the present invention encompassing the following to gain access through the entranceway:
face mask verification only
vaccination confirmed, and confirmation code only
vaccination confirmation code+RFID employee pass
face mask+confirmation code pass
face mask+temperature reading+confirmation code pass
face mask+temperature reading+confirmation code pass+RFID employee pass
temperature reading+vaccination confirmed confirmation code+RFID employee pass

Of course, these could be utilized in various combinations, according to the previously noted access criteria as needed, as would be apparent to one skilled in the art. And, in any scenario, these restrictions could be bypassed, if necessary or desired, through use of a by-pass code so that the above-noted protocols can be by-passed for passage. This could also entail use of a code entered through a keypad, amongst other possibilities, though this list is not limiting, nor all encompassing.

In an exemplary embodiment, the system of the present invention can further comprise a camera (in electronic communication with other components of the system) which could be utilized to dissuade, prevent or deter people from, for example, using another person's vaccine passport. In such a situation, the camera could take a photo each time a person tries access the passageway, and assist other components of the system in determining whether to allow (or deny) the visitor access.

In another embodiment of the present invention the unlocking of (or entry through) an entranceway, in addition to the previously noted criteria, can also be effected by a key, a manually typed code, an RFID or similar encoded tag (NFC tracking tag), biometrically scanned fingerprint, iris recognition reading or the like. In particular, iris recognition technology can be used as a form of biometric identification that can verify the uniqueness of an individual with exceptional accuracy, as would be understood by one skilled in the art.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. An access system for an entranceway comprising:
a processor mounted proximate to the entranceway;
a scanning device in electronic communication with the processor for permitting access through the entranceway when a visitor achieves an access allowed criteria selected from the group consisting of:
a vaccination confirmation of the visitor and a vaccination confirmation code;
the vaccination confirmation of the visitor and an RFID pass;
a face mask verification and the vaccination confirmation code;
the face mask verification, a verification of a set allowable temperature for the system to gain entry and the vaccination confirmation code;
the face mask verification, the verification of the set allowable temperature for the system to gain entry, the vaccination confirmation code and the RFID pass; and
the verification of the set allowable temperature for the system to gain entry, the vaccination confirmation code and the RFID pass.

2. The system of claim 1, further comprising a disinfectant dispenser in electronic communication with the system mounted proximate to the entranceway.

3. The system of claim 1, further comprising message conveying means mounted proximate to the entranceway and being in electronic communication with the system.

4. The system of claim 1, further comprising a thermal temperature sensor in electronic communication with the system wherein, when the thermal temperature sensor determines the visitor approaching the entranceway is not in compliance with the set allowable temperature for the system, the entranceway will remain in a closed position.

5. The system of claim 1, wherein the system is in electronic communication with Internet or other communications systems via Wi-Fi, radio or Bluetooth.

6. The system of claim 1, further comprising a scanning device in electronic communication with the system for detecting a confirmation that the visitor has tested negative for a communicable disease.

7. The system of claim 6, wherein the confirmation is selected from the group consisting of bar codes, a QR code, a datamatrix code, or machine readable optical labels.

8. The system of claim 5, wherein access through the entranceway is effected through use of a code entered through a keypad, an authorized swipe card, an RFID/NFC key fob or a code sent over the Internet or the other communications systems.

9. The system of claim 3, wherein the system is adapted for displaying an access allowed signal via the message conveying means to provide an indication to the visitor that passage is permitted or an access denied signal on the message conveying means to provide an indication to the visitor that passage is not permitted.

10. The system of claim 9, further comprising a facial recognition device in electronic communication with the system mounted proximate to the entranceway.

11. The system of claim 6, wherein the confirmation that the visitor has tested negative for the communicable disease is effected through use of an application on a mobile phone, which generates a confirmation code that is scanned at the entranceway.

12. The system of claim 6, wherein the confirmation that the visitor has tested negative for the communicable disease is effected through a printed confirmation code that is shown or scanned.

13. An automated access system for an entranceway comprising:
a facial recognition device mounted proximate to the entranceway;
a motion/presence detector mounted proximate to the entranceway and constructed and arranged for detecting an approach of a person to the entranceway;
a processor mounted proximate to the entranceway and being in electronic communication with the facial recognition device and the motion/presence detector; and
message conveying means mounted proximate to the entranceway and being in electronic communication with the facial recognition device, the message conveying means providing an access allowed signal when the facial recognition device determines that the person is wearing a mask, and denies entry when the person is determined to not be wearing a mask.

14. The system of claim 13, wherein the system is adapted for displaying an access allowed signal via the message conveying means to provide an indication to the perseon that passage is permitted or an access denied signal on the message conveying means to provide an indication to the person that passage is not permitted.

15. The system of claim 13, wherein the system is in electronic communication with Internet or other communications systems via Wi-Fi, radio or Bluetooth™.

16. The system of claim 13, further comprising a thermal temperature sensor in electronic communication with the system wherein, when the thermal temperature sensor determines the person approaching the entranceway is not in compliance with a set allowable temperature for the system, the entranceway will remain in a closed position.

17. The system of claim 16, further comprising a scanning device in electronic communication with the system for detecting a confirmation that the person has tested negative for a communicable disease.

18. The system of claim 15, wherein access through the entranceway is effected through use of a code entered through a keypad, an authorized swipe card, an RFID/ NFC key fob or a code sent over the Internet or the other communications systems.

19. The system of claim 16, wherein access through the entranceway is effected by selection from the group consisting of:
a vaccination confirmation of the person and a vaccination confirmation code;
the vaccination confirmation of the person and an RFID pass;
a face mask verification and the vaccination confirmation code;
the face mask verification, a verification of the set allowable temperature and the vaccination confirmation code;
the face mask verification, the verification of the set allowable temperature, the vaccination confirmation code and the RFID pass; and
the verification of the set allowable temperature, the vaccination confirmation code and the RFID pass.

20. A method for manufacturing an access system for an entranceway comprising the steps of:
providing a processor mounted proximate to the entranceway;
providing a scanning device in electronic communication with the processor for permitting access through the entranceway when a visitor achieves an access allowed criteria selected from the group consisting of:
a vaccination confirmation of the visitor and a vaccination confirmation code;
the vaccination confirmation of the visitor and an RFID pass;
a face mask verification and the vaccination confirmation code;
the face mask verification, a verification of the set allowable temperature and the vaccination confirmation code;
the face mask verification, the verification of the set allowable temperature, the vaccination confirmation code and the RFID pass; and
the verification of the set allowable temperature, the vaccination confirmation code and the RFID pass.
